(19) United States
(12) Patent Application Publication
(10) Pub. No.: US 2021/0318217 A1
(43) Pub. Date: Oct. 14, 2021

(54) MICRO-NANO INDENTATION TESTING DEVICE AND METHOD

(71) Applicant: XIANGTAN UNIVERSITY, XIANGTAN CITY (CN)

(72) Inventors: ZENGSHENG MA, XIANGTAN CITY (CN); XIN CHEN, XIANGTAN CITY (CN); KUN SUN, XIANGTAN CITY (CN); ZHICHUN ZHONG, XIANGTAN CITY (CN)

(21) Appl. No.: 17/203,103

(22) Filed: Mar. 16, 2021

(30) Foreign Application Priority Data
Apr. 10, 2020 (CN) 2020 102 791 85.X

(51) Int. Cl. G01N 3/42; G01N 3/06

(52) U.S. Cl. CPC G01N 3/42; G01N 3/066; G01N 2203/0676; G01N 2203/0286; G01N 2203/0682; G01N 2203/0082

(57) ABSTRACT

The disclosure discloses a micro-nano indentation testing device and method. A lower end of an upright post is fixedly connected to a base, a top support plate is fixedly connected to an upper end of the upright post, a precise pressing device is fixedly connected to the top support plate; a load detection module is fixedly connected to the lower end of the output shaft, an elastic element is sleeved on the output shaft, and two ends of the elastic element respectively press against the precise pressing device and the load detection module; the displacement detection module is fixedly connected to the lower end of the load detection module, an indenter fixer is fixedly connected to the lower end of the displacement detection module and used for fixedly mounting an indenter; and a stage is fixedly connected to the base and used for fixedly mounting a sample.

### CROSS REFERENCE TO RELATED APPLICATION

This patent application claims the priority of Chinese Patent Application No. 202010279185.X, entitled “Micro-nano Indentation Testing Device and Method” filed with the Chinese Patent Office on Apr. 10, 2020, which is incorporated by reference herein in its entirety.

### TECHNICAL FIELD OF THE DISCLOSURE

The present disclosure relates to the technical field of precise scientific instruments, in particular to a micro-nano indentation testing device and method.

### BACKGROUND OF THE DISCLOSURE

The instrumented indentation testing technology is to obtain load-displacement curves mainly by continuously recording the load and the indentation depth, and finally to obtain the hardness, elastic modulus and other parameters of the tested material by analyzing the curves. In the testing process, the finding of the indentation position and the measurement of the indentation residual area are avoided, thereby greatly reducing the testing error. The indentation load and depth data are obtained by the indentation test, and then a corresponding load-displacement relation curve is drawn. According to a proper mechanical model and derivation, abundant mechanical parameter information can be obtained from the curve analysis. At present, parameters such as hardness, elastic modulus, stress-strain curve, fracture toughness, creep property, fatigue property and adhesivity can be obtained by the nanoindentation test. Nanoindentation technology is becoming the first choice for mechanical properties testing of micro/nano-scale materials and structures due to its advantages such as simple test operation, high measurement efficiency and wide application range. Therefore, it is urgent to study a device for micro-nano indentation test in order to provide an effective method and experimental equipment for testing material performance parameters.

### SUMMARY OF THE DISCLOSURE

Some embodiments aim to provide a micro-nano indentation testing device and method, in order to solve the problems in the prior art. The present disclosure has a simple structure and a high precise measurement result.

In order to achieve the above object, the present disclosure provides the following solutions.

It is provided a micro-nano indentation testing device by the present disclosure, comprising a support module, a precise pressing device, a load detection module, a displacement detection module, an indenter fixer and a stage. The support module comprises a base, an upright post and a top support plate. A lower end of the upright post is fixedly connected to the base. The top support plate is fixedly connected to an upper end of the upright post. The precise pressing device is fixedly connected to the top support plate and an output shaft of the precise pressing device is vertically arranged downwards. The load detection module is fixedly connected to a lower end of the output shaft of the precise pressing device in a threaded manner. An elastic element is sleeved on the output shaft of the precise pressing device. Two ends of the elastic element respectively press against the precise pressing device and the load detection module. The displacement detection module is fixedly connected to a lower end of the load detection module. An indenter fixer is fixedly connected to a lower end of the displacement detection module, and used for fixedly mounting an indenter. The stage is fixedly connected to the base and used for fixedly mounting a sample.

In some embodiments, the load detection module comprises a force sensor and a fixing screw. The fixing screw penetrates through the force sensor and is fixedly connected with the force sensor. An upper end of the fixing screw is fixedly connected with the output shaft of the precise pressing device in a threaded manner. The displacement detection module comprises an adjusting bracket, a grating ruler and a reading head. The reading head is fixedly connected to the upright post. The adjusting bracket comprises a horizontal adjusting plate and a vertical mounting plate which are fixedly connected and are perpendicular to each other. The grating ruler is fixedly connected to the vertical mounting plate, and the grating ruler is arranged opposite to the reading head and is parallel to the reading head. The horizontal adjusting plate is provided with a through hole. A lower end of the fixing screw penetrates through the through hole and is threadedly connected with the indenter fixer. The indenter fixer presses the horizontal adjusting plate tightly against a lower surface of the force sensor.

In some embodiments, a reading head fixing bracket is fixedly connected to the upright post, and the reading head is fixedly connected to the reading head fixing bracket.

In some embodiments, the elastic element is a holddown spring, an upper end of the holddown spring presses against a lower surface of the precise pressing device by an upper gasket, and a lower end of the holddown spring presses against the load detection module by a lower gasket. In some embodiments, the stage comprises a bottom plate, fixing plates and movable plates. Each of two ends of the bottom plate is fixedly provided with respective one of the fixing plates. Two fixing plates are parallel to each other and arranged upwards in a manner of being perpendicular to the bottom plate. Two movable plates are arranged between the two fixing plates, and parallel to the fixing plates. Each of the fixing plates is threadedly connected with respective one of adjusting screws. An axis of each of the adjusting screws is perpendicular to the fixing plates. One end of each of the adjusting screws is rotatably connected with respective one of the two movable plates, and the two movable plates can be close to or far away from each other by rotating the adjusting screws.

In some embodiments, the precise pressing device is a linear stepping motor, and is fixedly connected to the top support plate via a bolt.

In some embodiments, the grating ruler is fixedly bonded on the vertical mounting plate.

In some embodiments, the reading head fixing bracket is provided with a long round hole, and a bolt penetrates through the long round hole and is threadedly connected with the reading head. It is provided a micro-nano indentation testing method utilizing the micro-nano indentation testing device, comprising the following steps of:

(1) connecting the precise pressing device with a computer, electrically connecting the load detection module and the displacement detection module with an analog-to-digital converter-based acquisition card, and electrically connecting the analog-to-digital converter-based acquisition card with the computer;

(2) mounting the indenter on the indenter fixer, and fixing the sample on the stage so that the sample is positioned right below the indenter;

(3) setting by the computer parameters of the indenter and the sample to be tested, which comprise a Poisson ratio and a thickness of a material used for the sample, a type of the indenter and parameters of a material used for the indenter, selecting a load control mode or a displacement control mode as a test loading mode, setting a maximum load value to be loaded or a maximum displacement value to be loaded, as corresponding control parameters, inputting loading time, load retention time and unloading time, setting a minimum response force value of the load detection module, and starting an indentation test;

(4) determining that the indenter is in contact with the sample when the load detection module detects the minimum response force value during a pressing process of the indenter, and implementing the indentation test according to the control parameters set and the loading time, the load retention time and the unloading time;

(5) acquiring load and displacement signals during a process of the indentation test by the analog-to-digital converter-based acquisition card, converting the load and displacement signals acquired into load and displacement values, and presenting the load and displacement values on a computer software interface to obtain load-displacement curves in the process of the indentation test, wherein the load-displacement curves comprise a load-displacement curve during loading and a load-displacement curve during unloading.

For the load-displacement curve during the loading, a loading force and a loading displacement (i.e. loading depth) follow the Kick's law:

P=Ch² (1)

According to the Oliver-Pharr theory, an unloading curve satisfies the following relationship:

P=B(h−h_{f})^{m} (2)

where, P is a loading force; h is a loading depth; C is a curvature of a loading curve; B is a fitting parameter; m is a shape parameter of the indenter; and h_{f} is a residual depth after complete unloading.

After taking logarithms for both sides of the expression (1) and (2), fitting by using the least square method to obtain m and B.

A contact stiffness S is defined as a slope of a top section of the unloading curve, expressed as:

$$S = \frac{d P}{d h} {\vert}_{h = {h}_{max}} = m {B ( {h}_{ma x} - {h}_{f} )}^{m - 1} \qquad ( 3 )$$

where, hₘₐₓ is a maximum indentation depth.

The contact stiffness S has the following relationship with a reduced modulus Eᵣ of the material:

$${E}_{r} = \frac{\sqrt{π}}{2 β \sqrt{A}} S \qquad ( 4 )$$

where, A is a contact area between the indenter and the sample to be tested; and β is a shape coefficient of the indenter.

For a contact depth h_{c},

$${h}_{c} = {h}_{max} - e \frac{{P}_{max}}{S} \qquad ( 5 )$$

where, ε is a factor related to a geometry of the indenter; and Pₘₐₓ is a maximum load during the unloading.

Due to limitations of a processing level of the indenter and tip abrasion in a use, a contact area function has to be calibrated by the following fitting expression:

$$A = {\sum }_{i = 0}^{8} {C}_{i} {h}_{c}^{1 / {2}^{i = 1}} = α {h}_{c}^{2} + {\sum }_{i = 0}^{7} {C}_{j} {h}_{c}^{1 / {2}^{f}} \qquad ( 6 )$$

where, Cᵢ is a curve fitting constant; and α is a parameter related to the shape of the indenter.

An indentation hardness H of the sample is expressed as:

$$H = \frac{{P}_{max}}{A} \qquad ( 7 )$$

An elastic modulus E of the sample has the following relationship with the reduced modulus Eᵣ:

$$\frac{1}{{E}_{r}} = \frac{1 - {v}^{2}}{E} + \frac{1 - {v}_{i}^{2}}{{E}_{i}} \qquad ( 8 )$$

thereby obtaining

$$E = ( 1 - {v}^{2} ) {( \frac{1}{{E}_{r}} - \frac{1 - {v}_{i}^{2}}{{E}_{i}} )}^{- 1} \qquad ( 9 )$$

where, Eᵢ and νᵢ are an elastic modulus and a Poisson ratio of the indenter respectively, and E and ν are an elastic modulus and a Poisson ratio of the sample respectively.

In some embodiments, in the step (5), a crack length of the sample is observed by a microscope, and a fracture toughness K_{IC} is calculated by an LEM (Lawn-Evans-Marshall) model:

$${K}_{IC} = α \cdot \sqrt{\frac{E}{H}} \cdot \frac{{P}_{max}}{{c}^{3 / 2}} \qquad ( 10 )$$

where, α is an LEM coefficient; E is an elastic modulus of the sample; H is an indentation hardness of the sample; Pₘₐₓ is a maximum load during the unloading; and c is a crack length of the sample.

Compared with the prior art, the present disclosure has the following technical effects.

The disclosure provides a micro-nano indentation testing device and a micro-nano indentation testing method. A precise pressing device is fixedly connected to a top support plate, a load detection module is fixedly connected to an output shaft of the precise pressing device in a threaded manner, an elastic element is sleeved on the output shaft, and the load detection module and the precise pressing device are pressed by the elastic element to provide a thread pre-tightening force, so that the load detection module cannot produce vertical displacement in an experiment process, the vertical displacement is caused by loose connection. In addition, the displacement detection module is fixedly connected below the load detection module, eliminating affections of structural flexibility of the parts above the load detection module and of the load detection module, so that the displacement measured by the displacement detection module is an accurate displacement of the indenter, thereby improving the measurement precision. The present disclosure has a simple structure, and is convenient to carry out an indentation test experiment.

### BRIEF DESCRIPTION OF THE DRAWINGS

In order to more clearly illustrate the embodiments of the present disclosure or technical solutions in the prior art, the accompanying drawings used in the embodiments will now be described briefly. It is evident that the drawings in the following description are only some embodiments of the disclosure, and that those skilled in the art can obtain other drawings from these drawings without involving any inventive effort.

FIG. 1 is a schematic diagram showing a three-dimensional structure of a micro-nano indentation testing device provided by the present disclosure;

FIG. 2 is a front view of the micro-nano indentation testing device of FIG. 1;

FIG. 3 is a side view of the micro-nano indentation testing device of FIG. 2;

FIG. 4 is an exploded view of the micro-nano indentation testing device of FIG. 1;

FIG. 5 is a relational graph of load-displacement curves during indentation experiments; and

FIG. 6 is a schematic cross-sectional view of an indentation during loading and unloading.

List of reference numerals: 1 support module, 2 precise pressing device, 3 load detection module, 4 displacement detection module, 5 stage, 6 base, 7 upright post, 8 top support plate, 9 output shaft, 10 adjusting bracket, 11 grating ruler, 12 reading head, 13 horizontal adjusting plate, 14 vertical mounting plate, 15 force sensor, 16 fixing screw, 17 elastic element, 18 indenter fixer, 19 reading head fixing bracket, 20 upper gasket, 21 lower gasket, 22 bottom plate, 23 fixing plate, 24 movable plate, 25 adjusting screw.

### DETAILED DESCRIPTION OF THE DISCLOSURE

In the following, the technical solutions in the embodiments of the present disclosure will be clearly and completely described with reference to the drawings in the embodiments of the present disclosure. Apparently, the described embodiments are only a part of the embodiments of the present disclosure, but not all the embodiments. Based on the embodiments of the present disclosure, all other embodiments obtained by a person of ordinary skill in the art without involving any inventive effort are within the scope of the present disclosure.

The present disclosure aims at providing a micro-nano indentation testing device and method, for solving the problems in the prior art. The present disclosure is simple in structure and high in measurement result precision.

To further clarify the above objects, features and advantages of the present disclosure, a more particular description of the disclosure will be provided in combination with the accompanying drawings and specific embodiments thereof.

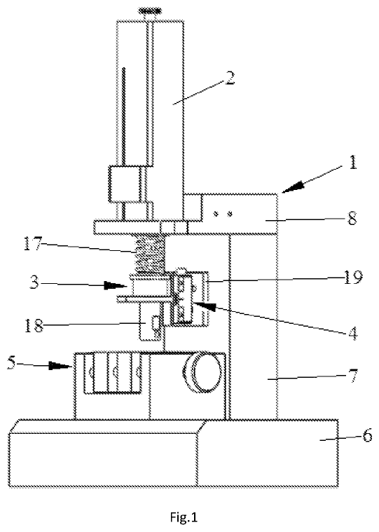

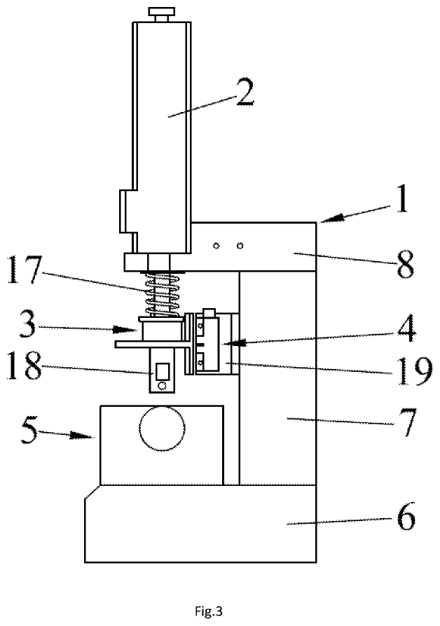

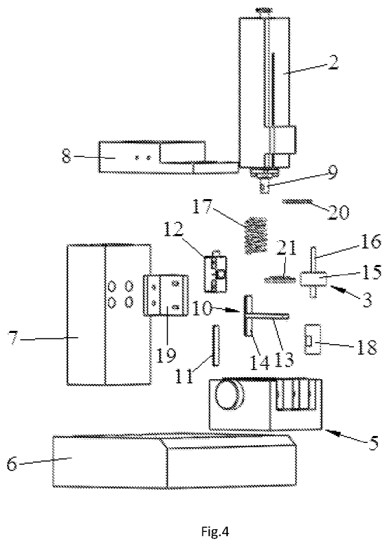

As shown in FIGS. 1-4, an embodiment of the disclosure provides a micro-nano indentation testing device which includes a support module 1, a precise pressing device 2, a load detection module 3, a displacement detection module 4 and a stage 5. The support module 1 includes a base 6, an upright post 7 and a top support plate B. A lower end of the upright post 7 is fixedly connected to the base 6. The top support plate 8 is fixedly connected to an upper end of the upright post 7. The precise pressing device 2 is fixedly connected to the top support plate 8, and an output shaft 9 of the precise pressing device 2 is arranged vertically downwards. The load detection module 3 is fixedly connected to a lower end of the output shaft 9 of the precise pressing device 2 in a threaded manner. An elastic element 17 is sleeved on the output shaft 9 of the precise pressing device 2, and two ends of the elastic element 17 respectively press against the precise pressing device 2 and the load detection module 3. The displacement detection module 4 is fixedly connected to a lower end of the load detection module 3. An indenter fixer 18 is fixedly connected to a lower end of the displacement detection module 4, and used for fixedly mounting an indenter. The stage 5 is fixedly connected to the base 6 and used for fixedly mounting a sample.

When an indentation test experiment is carried out, the precise pressing device 2 is fixedly connected to the top support plate 8, the load detection module 3 is fixedly connected to the output shaft 9 of the precise pressing device 2 in a threaded manner, the elastic element 17 is sleeved on the output shaft 9, and the load detection module 3 and the precise pressing device 2 are pressed by the elastic element 17 to provide a thread pre-tightening force, so that the load detection module 3 cannot produce vertical displacement due to loose connection in the experiment process. In addition, the displacement detection module 4 is fixedly connected below the load detection module 3, affection of structural flexibility of the parts above the load detection module 3 and the load detection module 3 is eliminated, so that the displacement measured by the displacement detection module 4 is an accurate pressing displacement of the indenter. The measurement precision is improved, the structure is simple, and the indentation test experiment is convenient to carry out. The base 6 and the upright post 7 are made of marble; the upright post 7 is fixedly connected with the base 6 via a screw; and the top support plate 8 is a rigid structural member, so that the deformation of the support module 1 in the operation process of the precise pressing device 2 is greatly reduced, and the displacement detection accuracy is improved.

As shown in FIGS. 1-4, the load detection module 3 includes a force sensor 15 and a fixing screw 16. The fixing screw 16 penetrates through the force sensor 15 and is fixedly connected with the force sensor 15. An upper end of the fixing screw 16 is fixedly connected with the output shaft 9 of the precise pressing device 2 in a threaded manner. The displacement detection module 4 includes an adjusting bracket 10, a grating ruler 11 and a reading head 12. The reading head 12 is fixedly connected to the upright post 7. The adjusting bracket 10 includes a horizontal adjusting plate 13 and a vertical mounting plate 14 which are fixed perpendicularly to each other. The grating ruler 11 is fixedly connected to the vertical mounting plate 14. The grating ruler 11 is arranged opposite to the reading head 12 and parallel to the reading head 12. The horizontal adjusting plate 13 is provided with a through hole. The lower end of the fixing screw 16 penetrates through the through hole and is threadedly connected with an indenter fixer 18. The indenter fixer 18 presses the horizontal adjusting plate 13 tightly against a lower surface of the force sensor 15. The micro-nano indentation testing device has a simple structure and is convenient to mount. The displacement in the test experiment can be measured by the grating ruler 11 and the reading head 12, such measurement is convenient and has high precision.

As shown in FIGS. 1-4, in an embodiment, a reading head fixing bracket 19 is fixedly connected to the upright post 7, and the reading head 12 is fixedly connected to the reading head fixing bracket 19. The embodiment has a simple structure and is easy to install.

As shown in FIGS. 1-4, the elastic element 17 is a holddown spring. An upper end of the holddown spring presses against a lower surface of the precise pressing device 2 by an upper gasket 20, and a lower end of the holddown spring presses against the load detection module 3 by a lower gasket 21, so that the pressing contact area of the holddown spring is increased. The upper gasket 20 and the lower gasket 21 each are sleeved on the output shaft 9. Annular protrusions are respectively arranged on a lower surface of the upper gasket 20 and an upper surface of the lower gasket 21. Two ends of the holddown spring are respectively sleeved on the outer peripheral surfaces of the upper and lower annular protrusions, so that the position of the holddown spring can be restricted to a certain extent, and a radial shaking amount of the holddown spring is reduced.

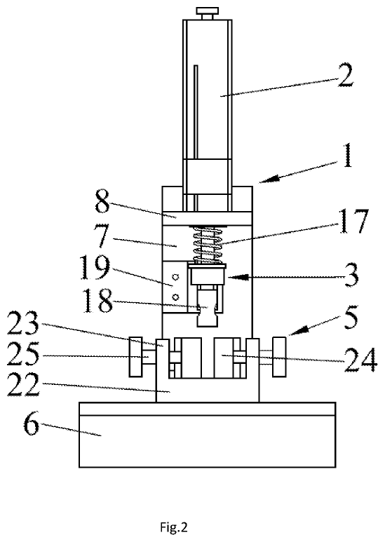

As shown in FIG. 2, the stage 5 includes a bottom plate 22, fixing plates 23 and movable plates 24. Each of two ends of the bottom plate 22 is fixedly provided with one of the fixing plates 23, and two fixing plates 23 are parallel to each other and are arranged upwards in a manner of being perpendicular to the bottom plates 22. Two movable plates 24 are arranged between the two fixing plates 23, and the two movable plates 24 are parallel to the fixing plates 23. Each of the two fixing plates 23 is threadedly connected with an adjusting screw 25, the axis of the adjusting screw 25 is perpendicular to the fixing plate 23. One end of each adjusting screw 25 is rotatably connected with one of the movable plates 24. The two movable plates 24 can be close to or far away from each other by rotating the adjusting screws 25. The structure is simple, and the operation is convenient.

In the embodiment, the precise pressing device 2 is a linear stepping motor, and is fixedly connected to the top support plate 8 via a bolt. The connection by the bolt is a fastening connection and convenient to disassemble and assemble.

In the embodiment, the grating ruler 11 is fixedly bonded on the vertical mounting plate 14, and the mounting is convenient.

In the embodiment, the reading head fixing bracket 19 is provided with a long round hole, and a bolt penetrates through the long round hole and is threadedly connected with the reading head 12, so that the position of the reading head 12 can be adjusted conveniently.

The micro-nano indentation testing method based on the micro-nano indentation testing device includes the following steps of:

(1) connecting a precise pressing device 2 with a computer, electrically connecting a load detection module 3 and a displacement detection module 4 with an analog-to-digital converter-based acquisition card, and electrically connecting the analog-to-digital converter-based acquisition card with the computer;

(2) mounting an indenter on an indenter fixer 18, and fixing a sample on a stage 5 so that the sample is positioned right below the indenter;

(3) setting by the computer parameters of the indenter and the sample to be tested, which include Poisson ratio and thickness of material used for the sample, indenter type and parameters of indenter material, selecting a load control mode or a displacement control mode as a test loading mode, setting a maximum load value to be loaded or a maximum displacement value to be loaded as corresponding control parameter, inputting loading time, load retention time and unloading time, setting a minimum response force value of the load detection module, and starting an indentation test;

(4) determining that the indenter is in contact with the sample at the moment when the load detection module 3 detects the minimum response force value during a pressing process of the indenter, and implementing the indentation test according to the set control parameters and the loading time, load retention time and unloading time;

(5) acquiring load and displacement signals in the test process by the analog-to-digital converter-based acquisition card, converting the acquired load and displacement signals into load and displacement values, and presenting the converted load and displacement values on a computer software interface to obtain load-displacement curves in the test process, wherein the load-displacement curves include a load-displacement curve during the loading process and a load-displacement curve during the unloading process.

For the load-displacement curve of the loading process, a loading force and a loading displacement (i.e. loading depth) follow the Kick's law:

P=Ch² (1)

According to the Oliver-Pharr theory, an unloading curve satisfies the following relationship:

P=B(h−h_{f})^{m} (2)

wherein, P is a loading force; h is a loading depth; C is a curvature of the loading curve. C depends on properties of materials to be tested and a geometry of the indenter; B is a fitting parameter; m is a shape parameter of the indenter; and h_{f} is a residual depth after complete unloading.

After taking logarithms for both sides of the expressions (1) and (2), fitting is performed by using the ordinary least square method to obtain m and B.

A contact stiffness S is defined as a slope of a top section of the unloading curve, and is expressed as:

$$S = \frac{d P}{d h} {\vert}_{h = {h}_{max}} = m {B ( {h}_{max} - {h}_{f} )}^{m - 1} \qquad ( 3 )$$

where, hₘₐₓ is a maximum indentation depth; for a Berkovich indenter and a Vickers indenter, β is taken as 1.034 and 1.012 respectively, and for a circular indenter, β is 1.

The contact stiffness S has the following relationship with a reduced modulus Eᵣ of the material:

$${E}_{r} = \frac{\sqrt{π}}{2 β \sqrt{A}} S \qquad ( 4 )$$

where, A is a contact area between the indenter and the sample to be tested; and β is a shape coefficient of the indenter.

For a contact depth h_{c},

$${h}_{c} = {h}_{max} - ɛ \frac{{P}_{max}}{S} \qquad ( 5 )$$

where, ε is a factor related to the geometry of the indenter, and values ε of a conical indenter, a Berkovich indenter and a flat indenter is 0.72, 0.75 and 1, respectively; Pₘₐₓ is a maximum load during unloading; and the expression (5) is only suitable for the case where the contact depth is less than the indentation depth, and cannot explain a plastic deformation of a bulge.

Due to limitations of a processing level of the indenter and tip abrasion during use, a contact area function needs to be calibrated to ensure the accuracy of the test result, and the following fitting expression is adopted for calibration:

$$A = {\sum }_{i = 0}^{8} {C}_{i} {h}_{c}^{1 / {2}^{i - 1}} = α {h}_{c}^{2} + {\sum }_{i = 0}^{7} {C}_{i} {h}_{c}^{1 / {2}^{i}} \qquad ( 6 )$$

where, Cᵢ is a curve fitting constant; α is a parameter related to the shape of the indenter; for an ideal Berkovich indenter, α=24.56, and for an ideal Vickers indenter, α=24.504.

An indentation hardness H of the sample is expressed as:

$$H = \frac{{P}_{max}}{A} \qquad ( 7 )$$

An elastic modulus E of the sample has the following relationship with the reduced modulus Eᵣ:

$$\frac{1}{{E}_{r}} = \frac{1 - {v}^{2}}{E} + \frac{1 - {v}_{i}^{2}}{{E}_{i}} \qquad ( 8 )$$

thereby obtaining

$$E = ( 1 - {v}^{2} ) {( \frac{1}{{E}_{r}} - \frac{1 - {v}_{i}^{2}}{{E}_{i}} )}^{- 1} \qquad ( 9 )$$

where, Eᵢ and νᵢ are an elastic modulus and a Poisson ratio of the indenter respectively, and E and ν are an elastic modulus and a Poisson ratio of the sample respectively. The elastic modulus and Poisson ratio of a diamond indenter are 1141 GPa and 0.07, respectively.

We generally adopt a pointed indenter indentation method for a fracture toughness. In step (5), a crack length of the sample is observed by means of a microscope, and the fracture toughness K_{IC} is calculated by an LEM (Lawn-Evans-Marshall) model:

$${K}_{IC} = α \cdot \sqrt{\frac{E}{H}} \cdot \frac{{P}_{max}}{{c}^{3 / 2}} \qquad ( 10 )$$

where, α is an LEM coefficient, generally 0.016; E is an elastic modulus of the sample; H is an indentation hardness of the sample; Pₘₐₓ is a maximum load in the unloading process; and c is a crack length of the sample.

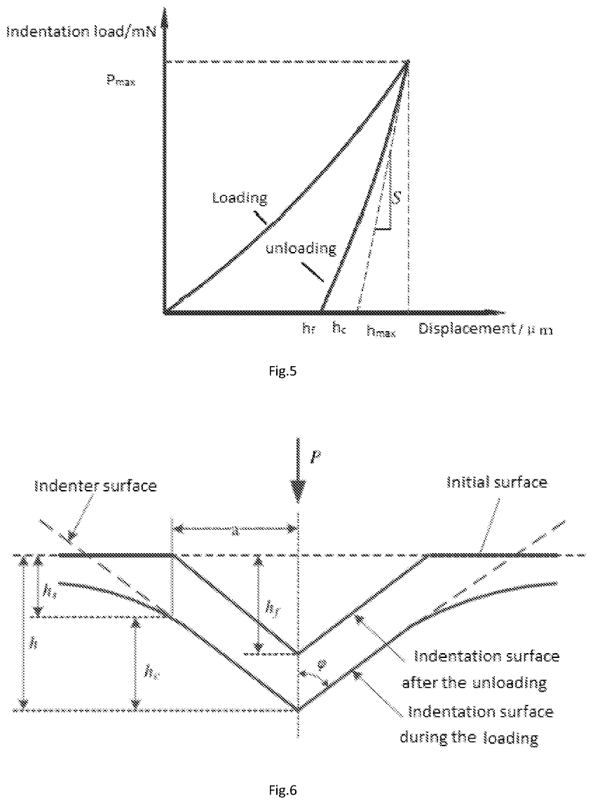

As shown in FIG. 5, in particular, the load-displacement curves of the loading and unloading process are obtained using the Berkovich indenter, and FIG. 6 is a schematic cross-sectional view of an indentation during the loading and unloading process using the conical indenter.

The micro-nano indentation testing device provided by the disclosure is small in size and high in integral structural rigidity, and ensures the stability of the testing system and the accuracy of the measuring result. The disclosure provides the effective experimental equipment and method for detecting material performance parameters, and plays a promoting role in the fields of material science, microelectronic technology, precision optics, thin film technology, ultra-precision machining technology, national defense and military industry, and so on.

The principles and implementation of the present disclosure have been described herein with specific examples, and the above embodiments are presented to aid in the understanding of the methods and core concepts of the present disclosure. Furthermore, changes will occur to those skilled in the art in both the detailed description and the scope of application according to the teachings of this disclosure. In conclusion, the contents of the description should not be construed as limiting the disclosure.

1. A micro-nano indentation testing device, comprising a support module, a precise pressing device, a load detection module, a displacement detection module and a stage; wherein the support module comprises a base, an upright post and a top support plate; a lower end of the upright post is fixedly connected to the base, the top support plate is fixedly connected to an upper end of the upright post; the precise pressing device is fixedly connected to the top support plate, and an output shaft of the precise pressing device is vertically arranged downwards; the load detection module is fixedly connected to a lower end of the output shaft of the precise pressing device in a threaded manner, an elastic element is sleeved on the output shaft of the precise pressing device, and two ends of the elastic element respectively press against the precise pressing device and the load detection module; the displacement detection module is fixedly connected to a lower end of the load detection module; an indenter fixer is fixedly connected to a lower end of the displacement detection module, and used for fixedly mounting an indenter, and the stage is fixedly connected to the base and used for fixedly mounting a sample.

2. The micro-nano indentation testing device according to claim 1, wherein, the load detection module comprises a force sensor and a fixing screw, the fixing screw penetrates through the force sensor and is fixedly connected with the force sensor, and an upper end of the fixing screw is fixedly connected with the output shaft of the precise pressing device in a threaded manner; the displacement detection module comprises an adjusting bracket, a grating ruler and a reading head; the reading head is fixedly connected to the upright post; the adjusting bracket comprises a horizontal adjusting plate and a vertical mounting plate which are fixedly connected and are perpendicular to each other; the grating ruler is fixedly connected to the vertical mounting plate, and the grating ruler is arranged opposite to the reading head and is parallel to the reading head; and the horizontal adjusting plate is provided with a through hole, a lower end of the fixing screw penetrates through the through hole and is threadedly connected with the indenter fixer, and the indenter fixer presses the horizontal adjusting plate tightly against a lower surface of the force sensor.

3. The micro-nano indentation testing device according to claim 2, wherein, a reading head fixing bracket is fixedly connected to the upright post, and the reading head is fixedly connected to the reading head fixing bracket.

4. The micro-nano indentation testing device according to claim 1, wherein, the elastic element is a holddown spring, an upper end of the holddown spring presses against a lower surface of the precise pressing device by an upper gasket, and a lower end of the holddown spring presses against the load detection module by a lower gasket.

5. The micro-nano indentation testing device according to claim 1, wherein, the stage comprises a bottom plate, fixing plates and movable plates; each of two ends of the bottom plate is fixedly provided with respective one of the fixing plates, and two fixing plates are parallel to each other and arranged upwards in a manner of being perpendicular to the bottom plate; two movable plates are arranged between the two fixing plates, and parallel to the fixing plates; and each of the fixing plates is threadedly connected with respective one of adjusting screws, an axis of each of the adjusting screws is perpendicular to the fixing plates, one end of each of the adjusting screws is rotatably connected with respective one of the two movable plates, and the two movable plates can be close to or far away from each other by rotating the adjusting screws.

6. The micro-nano indentation testing device according to claim 1, wherein, the precise pressing device is a linear stepping motor, and is fixedly connected to the top support plate via a bolt.

7. The micro-nano indentation testing device according to claim 2, wherein, the grating ruler is fixedly bonded on the vertical mounting plate.

8. The micro-nano indentation testing device according to claim 3, wherein, the reading head fixing bracket is provided with a long round hole, and a bolt penetrates through the long round hole and is threadedly connected with the reading head.

9. A micro-nano indentation testing method utilizing the micro-nano indentation testing device according to claim 1, the method comprising the following steps of:
(1) connecting the precise pressing device with a computer, electrically connecting the load detection module and the displacement detection module with an analog-to-digital converter-based acquisition card, and electrically connecting the analog-to-digital converter-based acquisition card with the computer;
(2) mounting the indenter on the indenter fixer, and fixing the sample on the stage so that the sample is positioned right below the indenter;
(3) setting by the computer parameters of the indenter and the sample to be tested, which comprise a Poisson ratio and a thickness of a material used for the sample, a type of the indenter and parameters of a material used for the indenter, selecting a load control mode or a displacement control mode as a test loading mode, setting a maximum load value to be loaded or a maximum displacement value to be loaded, as corresponding control parameters, inputting loading time, load retention time and unloading time, setting a minimum response force value of the load detection module, and starting an indentation test;
(4) determining that the indenter is in contact with the sample when the load detection module detects the minimum response force value during a pressing process of the indenter, and implementing the indentation test according to the control parameters set and the loading time, the load retention time and the unloading time;
(5) acquiring load and displacement signals during a process of the indentation test by the analog-to-digital converter-based acquisition card, converting the load and displacement signals acquired into load and displacement values, and presenting the load and displacement values on a computer software interface to obtain load-displacement curves in the process of the indentation test, wherein the load-displacement curves comprise a load-displacement curve during loading and a load-displacement curve during unloading;
for the load-displacement curve during the loading, a loading force and a loading displacement (i.e. loading depth) following the Kick's law:
P=Ch² (1)
according to the Oliver-Pharr theory, an unloading curve satisfying the following relationship:
P=B(h−h_{f})^{m} (2)
wherein, P being a loading force; h being a loading depth; C being a curvature of a loading curve; B being a fitting parameter; m being a shape parameter of the indenter; and h_{f} being a residual depth after complete unloading;
after taking logarithms for both sides of the expression (1) and (2), fitting by using the least square method to obtain m and B;
a contact stiffness S being defined as a slope of a top section of the unloading curve, expressed as:
$$S = \frac{d P}{dh} {\vert}_{h = {h}_{max}} = {mB ( {h}_{max} - {h}_{f} )}^{m - 1} \qquad ( 3 )$$
wherein, hₘₐₓ being a maximum indentation depth;
the contact stiffness S having the following relationship with a reduced modulus Eᵣ of the material:
$${E}_{r} = \frac{\sqrt{π}}{2 β \sqrt{A}} S \qquad ( 4 )$$
wherein, A being a contact area between the indenter and the sample to be tested; and β being a shape coefficient of the indenter;
for a contact depth h_{c},
$${h}_{c} = {h}_{max} - ɛ \frac{{P}_{max}}{S} \qquad ( 5 )$$
wherein, ε being a factor related to a geometry of the indenter; and Pₘₐₓ being a maximum load during the unloading;
due to limitations of a processing level of the indenter and tip abrasion in a use, a contact area function having to be calibrated by the following fitting expression:
$$A = {\sum }_{i = 0}^{8} {C}_{i} {h}_{c}^{1 / {2}^{i - 1}} = α {h}_{c}^{2} + {\sum }_{i = 0}^{7} {C}_{i} {h}_{c}^{1 / {2}^{i}} \qquad ( 6 )$$
wherein, Cᵢ being a curve fitting constant; and α being a parameter related to the shape of the indenter;
an indentation hardness H of the sample being expressed as:
$$H = \frac{{P}_{max}}{A} \qquad ( 7 )$$
an elastic modulus E of the sample having the following relationship with the reduced modulus Eᵣ:
$$\frac{1}{{E}_{r}} = \frac{1 - {v}^{2}}{E} + \frac{1 - {v}_{i}^{2}}{{E}_{i}} \qquad ( 8 )$$
thereby obtaining
$$E = ( 1 - {ν}^{2} ) {( \frac{1}{{E}_{r}} - \frac{1 - {v}_{i}^{2}}{{E}_{i}} )}^{- 1} \qquad ( 9 )$$
wherein, Eᵢ and νᵢ being an elastic modulus and a Poisson ratio of the indenter respectively, and E and ν being an elastic modulus and a Poisson ratio of the sample respectively.

10. The micro-nano indentation testing method according to claim 9, wherein, in the step (5), a crack length of the sample is observed by a microscope, and a fracture toughness K_{IC} is calculated by an LEM (Lawn-Evans-Marshall) model:
$${K}_{IC} = α \cdot \sqrt{\frac{E}{H}} \cdot \frac{{P}_{max}}{{c}^{3 / 2}} \qquad ( 10 )$$
wherein, α is an LEM coefficient; E is an elastic modulus of the sample; H is an indentation hardness of the sample; Pₘₐₓ is a maximum load during the unloading; and c is a crack length of the sample.
